(19) United States
(12) Patent Application Publication
(10) Pub. No.: US 2008/0073091 A1
(43) Pub. Date: Mar. 27, 2008

(54) Impact piston

(76) Inventor: Steven James Lindsay, Kearney, NE (US)

Correspondence Address: Steve J. Lindsay, 3714 West Cedar Hills Drive, Kearney, NE, 68845, US

(21) Appl. No.: 11/511,693

(22) Filed: Aug. 28, 2006

(51) Int. Cl. B25B 21/02

(52) U.S. Cl. 173/1

(57) ABSTRACT

An improved piston for a pneumatic hand engraving impact power tool. More specifically, the invention provides a piston for an engraving impact tool made from a material that is more dense than steel. In addition the invention provides an improved piston for fine engraving using a microscope utilizing a soft faced piston.

### BACKGROUND OF THE INVENTION

1. Field of Invention

The invention relates to an improved piston for a pneumatic hand engraving impact tool. More specifically, the invention provides a non-filled piston for an engraving impact tool made from a material that is more dense than steel.

2. Description of Prior Art

In recent times impact power tools as disclosed in U.S. Pat. Nos. 6,095,256, 6,488,102, 6,530,435, and 6,691,798 have been developed to aid the jeweler, engraver or artist with a hand power graver that is the physical size of the traditional graver. These tools as well as older prior art hand engraving power tools disclosed in U.S. Pat. Nos. 3,393,755, 4,903,784, 5,203,417, and 5,515,930 use an internal steel or stainless steel piston to impact against an anvil for driving a graver or chisel through the material being carved. Disclosed in U.S. Pat. No. 4,694,912 is a large hand held impact tool that does not have a palm handle and that is too large to fit into the palm of a hand, as the original non powered palm gravers and the more modern palm sized impact engraving tools do. Because of this, the piston in this large tool is physically larger (½ to ⅝′ in diameter) and it was therefore more practical to hollow it out and fill it with a heavy material such as lead or lead shot. With a palm held impact tool, the piston diameter is in the size range of ¼′ to ⅜′ and the benefit of trying to hollow out a piston this size and filling it with a heavy material or lead is minimal because very little piston weight is gained. To keep the tools as small as the hand palm graver and yet have them deliver a lot of power when needed, it is necessary that the design of the tool and piston have as much mechanical advantage in a small package as possible.

### OBJECTS AND SUMMARY OF THE INVENTION

It is the object of this invention to provide an improved non-filled piston for a hand engraving power impact tool made from a material that is more dense and heavy than steel or stainless steel. A non-filled piston made from a denser and heavier material will provide harder, more efficient impacts in a small package for driving a graver or chisel. In addition it is an object of this invention to provide an improved piston for fine engraving using a microscope utilizing a soft face on the impacting portion of the piston.

### DETAILED DESCRIPTION OF THE PREFERRED EMBODIMENT

The preferred embodiment of the present invention is a non-filled impact piston made from a material with more density than 12 grams per cubic centimeter which will impact against an anvil within a bore of a pneumatic hand held impact power tool such as disclosed in U.S. Pat. Nos. 6,095,256, 6,488,102, 6,530,435, 6,691,798, 3,393,755, 4,694,912, 4,903,784, 5,203,417, and 5,515,930.

Applicant has discovered that making such a piston from a tungsten alloy or a carbide alloy will provide these types of impact power tools much more impact power. It is a benefit to users to provide additional power to these types of tools and yet keep the tools at the size of an original palm push sized graver. A heavy tungsten or carbide piston that is the same physical size as a lighter steel piston provides this benefit. In other words, by providing a heavy tungsten or carbide piston the inertia of each impact is much more than that of a steel or stainless steel piston made at the same size.

The following are the densities of various materials:

### Note: g/cc=grams per cubic centimeter

Pure Tungsten 18.8 g/cc

Tungsten Alloys 17.1 g/cc to 18.5 g/cc (90% to 97% Tungsten)

Carbide Alloys 13 g/cc to 15.1 g/cc (75% to 96% Carbide)

Platinum 21.3 g/cc

Iridium 22.1

Rhodium 12.4 g/cc

Pure Gold 19.3 g/cc

Lead 11.3 g/cc

Molybdenum 10 g/cc

Cobalt 8.9 g/cc

Pure Copper 8.9 g/cc

Nickel 8.5 g/cc

Brass 8.5 g/cc

Stainless Steel 8 g/cc

Steel 7.8 g/cc

High Speed Tool Steel 8.75 g/cc

Carbon Tool Steel 7.7 g/cc

Titanium 4.6 g/cc

Applicant has also discovered that a nylon or plastic type material on the face of a piston used in the hand engraving pneumatic tools will give more delicate impacts. This is useful for fine engraving done using a microscope and/or to quiet the impacts. This nylon or plastic material can be utilized on a lighter titanium piston, medium weighted stainless or steel piston or heavy weight tungsten or carbide piston. One way the nylon or plastic can be attached to the front end of the piston is by drilling a hole in the front end of the piston approx 0.125′ in depth and to a size to provide a drive fit to the diameter of a short piece of nylon or plastic rod. The rod is driven in the hole and trimmed to length, leaving around 0.010′ to 0.050′ of it exposed out from metal piston end face.

### Conclusion, Ramifications, and Scope

Accordingly, the reader will see that the invention provides an improved non-filled piston for an impact power tool providing additional power which an engraver, jeweler or artist can utilize for his or her work. It also provides a soft faced piston for more delicate impacts.

Although the invention has been described with reference to the preferred embodiment, it is noted that equivalents may be employed and substitutions made herein without departing from the scope of the invention as recited in the claims. For example other materials with densities greater than 12 g/cc can be substituted for those disclosed. Accordingly, the scope of the invention should be determined not by the embodiment disclosed and described, but by the appended claims and their legal equivalents.

1-16. (canceled)

17. A hand engraving pneumatic impact tool for use with a supply of pressurized fluid comprising:
a cylinder;
a piston received in said cylinder for bi-directional movement within said cylinder; and
said piston made from a material with a density greater than 12 grams per cubic centimeter.

18. A hand engraving pneumatic impact tool as recited in claim 17 wherein:
said piston made from an alloy containing tungsten.

19. A hand engraving pneumatic impact tool as recited in claim 18 wherein:
said piston made from an alloy containing copper.

20. A hand engraving pneumatic impact tool as recited in claim 17 wherein:
said piston made from an alloy containing carbide.

21. A hand engraving pneumatic impact tool as recited in claim 20 wherein:
said piston made from an alloy containing cobalt.

22. A hand engraving pneumatic impact tool as recited in claim 17 wherein:
said piston is not filled with a heavy second material in a hollowed out portion within itself.

23. A hand engraving pneumatic impact tool for use with a supply of pressurized fluid comprising:
a cylinder;
a piston received in said cylinder;
an impact surface at one end of said cylinder for said piston to impact against; and
said piston having a soft face that engages with said impact surface.

24. A hand engraving pneumatic impact tool as recited in claim 23 wherein:
said soft face is made from either a nylon, a rubber, a leather, a urethane, a thermoplastic or a elastomer material.

25. A method of hand engraving an object comprising:
providing an impact power tool having a cylinder having a first end and a second end;
a piston received in said cylinder for bi-directional movement between said first end and said second end;
an impact surface positioned at said first end of said cylinder for said piston to impact against; and
said piston made from a material with a density greater than about 12 grams per cubic centimeter;

26. A method of hand engraving an object as recited in claim 25 wherein: said piston made from an alloy containing tungsten.

27. A method of hand engraving an object as recited in claim 25 wherein: said piston made from an alloy containing carbide.

28. A method of hand engraving an object as recited in claim 25 wherein: said piston made from an alloy containing molybdenum.

29. A method of hand engraving an object as recited in claim 25 wherein: said piston made from a material containing lead.

30. A method of hand engraving an object as recited in claim 25 wherein: said piston made from a material containing gold.

31. A method of hand engraving an object as recited in claim 25 wherein: said piston made from a material containing tungsten, carbide, and cobalt.

32. A method of hand engraving an object as recited in claim 25 wherein: said piston made from a material containing tungsten and copper.

33. A method of hand engraving an object as recited in claim 25 wherein: said piston made from a material containing tungsten, molybdenum.
